(19) United States
(12) Patent Application Publication
(10) Pub. No.: US 2005/0287894 A1
(43) Pub. Date: Dec. 29, 2005

(54) Articles of enhanced flamability resistance

(76) Inventors: John Burns, Simpsonville, SC (US); Kim Van Voorhis, Rutherfordton, NC (US); George Hairston, Spartanburg, SC (US); Warren Stidham, Cohutta, GA (US)

Correspondence Address: James M. Robertson, 233 S. Pine Street, Spartanburg, SC, 29303, US

(21) Appl. No.: 10/884,495

(22) Filed: Jul. 2, 2004

Related U.S. Application Data
(60) Provisional application No. 60/484,794, filed on Jul. 3, 2003.

(51) Int. Cl. B32B 27/04; B32B 5/02; B32B 27/12

(52) U.S. Cl. 442/136; 442/138; 442/144; 428/920; 428/921

(57) ABSTRACT

A textile structure of enhanced flame resistance and articles formed therefrom. The textile structure is adapted to provide enhanced levels of flame resistance so as to withstand flame impingement for prolonged periods.

### CROSS-REFERENCE TO RELATED APPLICATION

This application is a non-provisional filing of prior filed copending provisional application 60/484,794 in the name of Burns et al. filed Jul. 3, 2003.

### TECHNICAL FIELD

This invention relates generally to articles such as mattresses, box springs, seating furniture and appliances which incorporate textile materials imparting enhanced resistance to flammability.

### BACKGROUND OF THE INVENTION

In a number of environments it is desirable for textile components to have a degree of flame resistance. One environment of textile use where flame resistance is desirable is as covering materials for mattresses and box springs. Another environment of textile use where flame resistance is desirable is in furniture upholstery. Still another environment where flame resistance is desirable is in linings for heat generating appliances such as stoves, clothes dryers and the like.

In the past, flame resistance has typically been achieved by use of synthetic flame retardant refractory fiber constituents such as asbestos, metal oxides and the like and/or by application of chemical flame resisting saturating chemical agents. While such practices have permitted the production of products having a relatively high degree of flame resistance, the practices have been relatively complex and costly to carry out. Moreover, such flame resistant fiber materials and chemical treatments may cause undesirable reactions in some users.

Various testing procedures are used to evaluate the flammability characteristics of textile materials and articles formed therefrom. By way of example only, and not limitation, testing procedures for measuring the flame resistance of a mattress and associated foundation (i.e. box spring) are set forth in Technical Bulletin 603 issued by the State of California Department of Consumer Affairs Bureau of Home Furnishings and Thermal Insulation in North Highlands, California, USA the contents of which will be well known to those of skill in the art and which are hereby incorporated by reference as if fully set forth herein. In this testing procedure a pair of propane burners are utilized to mimic the heat flux levels and durations imposed on a mattress and foundation by burning bedclothes. These burners impose differing fluxes for differing times on the mattress top and on the sides of the mattress and any underlying foundation. The resulting smoke plume is captured and heat release levels are measured by oxygen consumption calorimetry using instrumentation as set forth in ASTM E 1590 (incorporated by reference). The test method also provides a measure of the emissions of carbon monoxide and carbon dioxide.

In the test of Technical Bulletin 603, propane gas from a source such as a bottle having a net heat of combustion of 46.5±0.5 MJ/kg (nominally 99% to 100% propane) is delivered through a multi-orifice stainless steel manifold burner having 34 openings (17 on each side of a T junction with the gas inlet) arranged to impact the top of the mattress. Propane is simultaneously delivered through a similar manifold burner having 28 openings (14 on each side of a T junction with the gas inlet) arranged to impact the sides the mattress/foundation. The openings in the burners are drilled using a #56 drill and are 1.17 mm to 1.22 mm in diameter. The gas flow rate to the top burner is 12.9±0.1 L/min at a pressure of 101±5 kPa (standard atmospheric pressure) and a temperature of 22±3 degrees Celsius corresponding to a flow rate of about 0.38 L/min per opening. The gas flow rate to the side burner is 6.6±0.5 L/min at a pressure of 101±5 kPa (standard atmospheric pressure) and a temperature of 22±3 degrees Celsius corresponding to a flow rate of about 0.24 L/min per opening. The duration of gas flow is 70 seconds for the top burner and 50 seconds for the side burner.

Under the testing criteria of Technical Bulletin 603 a mattress or a mattress/box spring set is considered to pass if the maximum rate of heat release is less than 150 kW and the total heat release is less than 25 MJ in the first 10 minutes of the test.

Another flammability testing procedure applicable to furniture is set forth in British Standard 5852 (incorporated herein by reference) which describes test methods for assessing the ignitability of upholstered composites for seating covers and fillings when subjected to flaming sources of various thermal output ranges. More particularly, this standard test method utilizes a frame supporting segments of the material to be tested in an arrangement corresponding to the intersection between the seat and the back of a chair. A crib assembly formed from seasoned planks of softwood is constructed in a predefined manner including a layer of flammable lint and is thereafter ignited at an interior position on the seat in contact with the back. If flaming or progressive smoldering is not observed, the test is repeated at a different location. If flaming or progressive smoldering is still not observed, the material is considered to pass the test criteria. In this regard, any composite that produces externally detectable amounts of smoke, heat or glowing 60 minutes after ignition of the crib is considered to display progressive smoldering. Different crib constructions are utilized to mimic different levels of ignition. In the so called “crib 5” test the crib is formed from 10 layers (each of two sticks) for a total of 20 sticks wherein the sticks are 40±2 mm in length with a square section of 6.5 mm±0.5 mm. The total mass of sticks is 17 grams±1 gram. The approximate lint dimensions are 40 mm×40 mm.

### SUMMARY OF THE INVENTION

The present invention provides advantages and alternatives over the prior art by providing a mattress with or without an associated box spring incorporating a barrier fabric construction including a predominant percentage of non-refractory fiber which barrier fabric construction has substantial flame resistance when subjected to flame conditions corresponding to those as set forth in Technical Bulletin 603. The barrier fabric construction may form the exterior surface of the mattress and/or box spring or may be disposed beneath an additional decorative fabric covering layer. The present invention also provides furniture incorporating a fabric construction as part of the covering including a predominant percentage of non-refractory fiber which covering fabric has substantial flame resistance when subjected to flame conditions corresponding to those set forth in the crib 5 test of British Standard 5852. The present invention also provides insulating material of fibrous character incorporating a predominant percentage of non-refractory fiber for use in heat generating appliances.

### BRIEF DESCRIPTION OF THE DRAWINGS

The following drawings which are incorporated in and which constitute a part of this specification illustrate various exemplary embodiments and practices according to the present invention and, together with the general description above and the detailed description set forth below, serve to explain the principles of the invention wherein:

FIG. 1 is a cross-section of an exemplary coated fabric construction of flame resistant character;

FIG. 2 illustrates open flame impingement testing with the fabric construction of FIG. 1 in a horizontal position corresponding to the top of a mattress or horizontal seat portion of a chair or sofa;

FIG. 3 illustrates open flame impingement testing with the fabric construction of FIG. 1 in a vertical position corresponding to the side of a mattress or vertical back support portion of a chair or sofa;

FIG. 4 is a perspective view of a mattress and box spring set incorporating an exterior fabric covering;

FIGS. 5-5B are cross-sectional views of exemplary composite coverings for mattresses and/or box springs including a flame barrier fabric;

FIG. 6 is a perspective view of a seating structure incorporating an upholstery outer surface;

FIGS. 7 and 7A are cross-sectional views of exemplary upholstery fabrics including a flame barrier constituent; and

FIG. 8 is a perspective view of a heat generating appliance including an insulating layer of flame barrier fabric incorporating the multi-layer composite of FIG. 6.

While the present invention has been illustrated and generally described above and will hereinafter be described in conjunction with certain potentially preferred embodiments, procedures, and practices, it is to be understood that in no case is the invention to be limited to such illustrated and described embodiments, procedures, and practices. On the contrary, it is intended that the present invention shall extend to all alternatives, modifications, and equivalents as may embrace the principles of the present invention within the true scope and spirit thereof.

### DESCRIPTION OF PREFERRED EMBODIMENTS

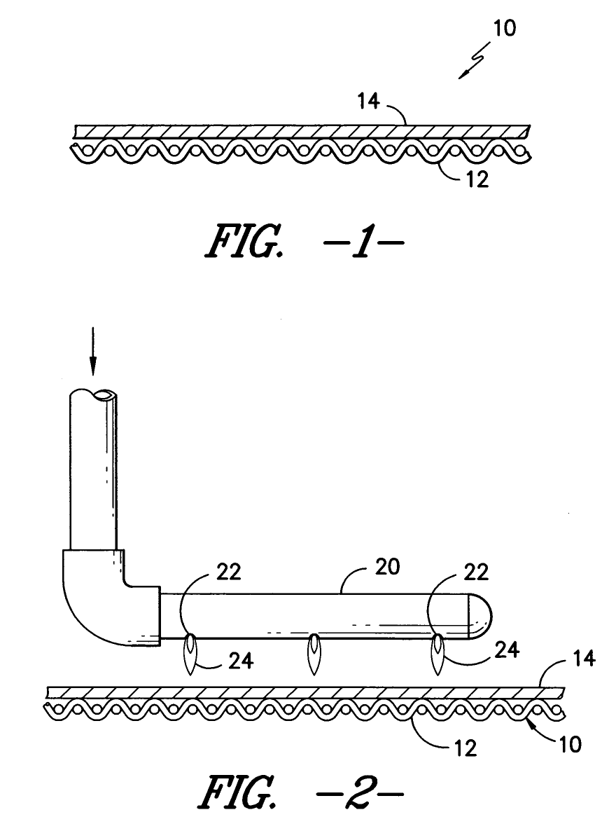

Reference will now be made to the various drawings wherein to the extent possible like reference numerals are utilized to designate corresponding components throughout the various views. In FIG. 1, there is illustrated a fabric construction 10 of enhanced flame resistance suitable for use alone or in combination with one or more covering fabric layers to impart flame resistance to an article. As will be appreciated, for purposes of description various elements of fabric construction 10 are illustrated with enhanced dimensions and are thus not necessarily in scale relative to one another.

The exemplary construction illustrated includes a textile layer 12 provided with a coating 14 across at least a portion of one side. The coating may also be disposed across at least a portion of both sides if desired. According to one potentially preferred practice the coating 14 is of a so called “intumescent” character such that it undergoes a swelling and charring when exposed to a flame in a manner as will be described further hereinafter. By way of example only, and not limitation, the coating 14 preferably includes a polymer binder such as a latex acrylic co-polymer emulsion and a flame retardant composition intermixed with the polymer binder as well as dispersants and/or thickeners as desired to achieve desired physical characteristics to promote coating. The flame retardant composition preferably includes (i) an acid donor such as ammonium polyphosphate, mono-ammonium phosphate, diammonium phosphate, potassium tripolyphosphate or combinations thereof; (ii) a carbon donor such as dipentaerythritol (DPE), pentaerythritol, polyol, chlorinated paraffin, or a combinations thereof; and (iii) a blowing agent such as melamine, urea, dicyandiamide or combinations thereof.

The constituents of the flame retardant composition are preferably provided in powder or a granule form and dispersed in a solvent such as water, alcohols, napthas, aromatic hydrocarbon, or a combinations thereof prior to mixing with the binder. Fillers and pigments such as titanium dioxide, zinc oxide, silicates, carbon black, calcium carbonate and the like may also be added. By way of example only, and not limitation, various flame retardant compositions for use in the coating 14 are described in U.S. Pat. No. 4,879,320 to Hastings the content of which is hereby incorporated by reference as if fully set forth herein.

According to one contemplated practice, the textile layer 12 is a woven or knit fabric formed of fibrous material such as cotton, virgin or grey wool, polyester, nylon, and the like including blends of such materials. It is also contemplated that other textile constructions formed of such fiber materials and blends thereof such as nonwovens including needlepunched felts and the like may likewise be used if desired. According to one potentially preferred practice, it is contemplated that the textile layer 12 will be formed predominantly of fiber materials other than metal oxides and will preferably be substantially free of refectory fibers such as aluminum oxide, silicone dioxide and/or other metal oxides. That is, metal oxides and other refractory fibers preferably make up no more than 0 to about 49%, more preferably 0 to about 20%, and most preferably 0 to 5% of the fibrous textile layer 12. Thus, according to the potential preferred practice the fibrous textile layer 12 is substantially free of refractory metal oxide fibers.

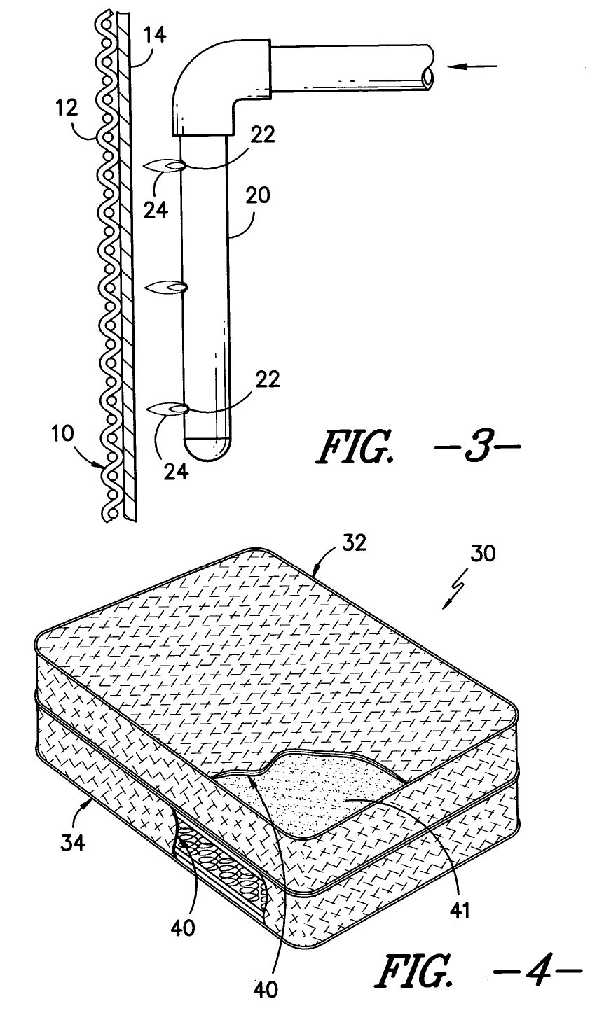

According to one exemplary practice the coating 14 is applied across one side of the textile layer 12 as a coating composition made up of about 50% by weight water and about 50% by weight polymeric binder (plus flame retardant composition). In one exemplary construction approximately 8 ounces per square yard (based on the dry weight of the coating) was applied to a 4 ounce per square yard woven cotton fabric. In order to evaluate the flame retardancy character of such a coated fabric construction a sample of the coated fabric as described above incorporated a coating as set forth in Table 1 below was subjected to direct flame impingement in both a horizontal and vertical orientation using a propane burner 20 as shown in FIGS. 2 and 3. While the textile layer utilized in the test was woven cotton, it is anticipated that similar performance results will be achieved for other textile constructions.

TABLE 1

| Constituent | % By Weight |
|---|---|
| Latex Binder (EVC acrylic copolymer) | 30-40 |
| Ammonium polyphosphate | 5-10 |
| Pentaerythritol | 5-10 |
| Chlorinated paraffin wax | 5-10 |
| Melamine | 15-20 |
| Dispersant (Ethoxylated decyl alcohol) | 0-1 |
| Acrylic Thickener (Acrysol ASE-60) | 0-1 |
| Water | 25-40 |

Of course, it is to be understood that the above formulation is exemplary only and that other formulations may be suitable. By way of example only, and not limitation, it is contemplated that the formula of Table 1 may be modified by substituting a dipentaerythritol/pentaerythritol mix for the pentaerythritol. It is also contemplated that the formula may be modified by use of Vinyl acetate-ethylene copolymer binder in substitution for the acrylic copolymer. It is also contemplated that the dispersant may be modified by use of lignin sulfonate, sulfonated naphthalene condensate or combinations thereof in conjunction with the ethoxylated decyl alcohol. Component percentages will remain the same.

As previously indicated, in the potentially preferred practice the coating formulation over the fabric establishes an intumescent coating system. In the event of a fire the components of the coating react together as a result of the temperature increase to form a carbon foam. This foam attains a thickness of about 10 to 100 times that of the originally applied coating and isolates the textile substrate material through its low thermal conductivity. The system provides enhanced flame protection whether the flame impinges the coated or uncoated side of the fabric. Moreover, protection is provided whether the fabric is coated on one or both sides. Protection is believed to be slightly superior when the flame is applied to a coated side.

As illustrated, the propane burner 20 utilized in the testing procedure incorporates three burner holes 22 sized to yield a propane flow rate per opening corresponding to the per opening flow rate used in the practice outlined in Technical Bulletin 603 as previously described. That is, in the horizontal testing condition illustrated in FIG. 2 the propane burner 20 is configured to deliver approximately 0.38 liters per minute of propane per opening. In the vertical testing arrangement illustrated in FIG. 3, the propane burner 20 is adjusted by means of a flow control (not shown) to deliver approximately 0.24 liters per minute of propane per opening. The burner holes each have a diameter in the range of 1.17 mm to 1.22 mm and are equally spaced 8.5 mm apart. In both the horizontal and vertical test conditions the flame 24 impacted directly against the coating 14. The horizontal test (FIG. 2) was carried out for 70 seconds. The vertical test (FIG. 3) was carried out for 50 seconds. In both the vertical and horizontal tests the fabric charred but did not burn through and self extinguished immediately upon termination of gas flow.

The ability of the fabric construction 10 to remain intact when subjected to flame conditions as outlined above demonstrates the substantial flame resistance of such materials despite the absence of any significant percentage of refectory fiber material. It is contemplated that such fabric constructions may find particular application as a flame barrier in various environments of use so as to impart substantially improved levels of flame resistivity.

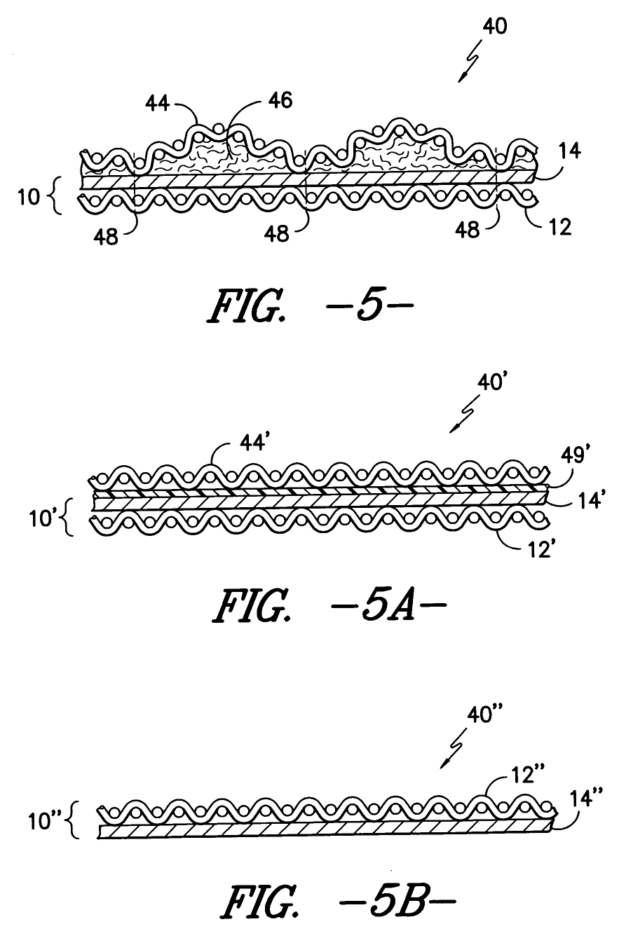

By way of example only, in FIG. 4 there is illustrated a bedding construction 30 including a mattress 32 and supporting box spring 34. As shown, the mattress 32 and the box spring 34 each include a covering 40 having an outer surface which defines the exterior disposed over interior portions such as a mattress core 41. As will be appreciated, the mattress core 41 may be of any suitable construction including foam, spring structures, fluid bladders, and the like including a combination of such elements as be known to those of skill in the art.

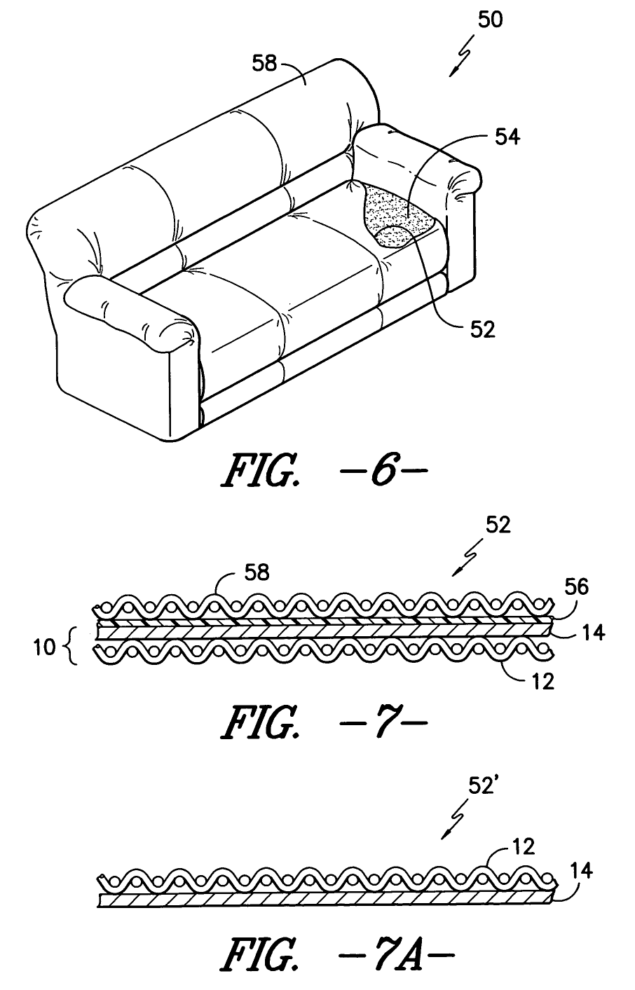

As illustrated in FIG. 5, according to one embodiment, the covering 40 may include a decorative outer layer 44 such as a woven or knit mattress ticking fabric of polyester or the like as will be well known to those of skill in the art. As shown, the outer layer 44 may be quilted in place across the flame retardant fabric construction 10 by a patterned arrangement of quilting yarns 48. If desired, a high loft material 46 such as polyester fiber or the like may be held between the outer layer 44 and the flame retardant fabric construction to enhance cushioning. Upon exposure to an exterior flame source, the outer layer 44 and any underlying high loft material will tend to melt and burn through fairly quickly. However, the flame retardant fabric construction 10 will act as a flame barrier against burn through into the interior of the mattress and or box spring.

According to another embodiment illustrated in FIG. 5A, (in which elements corresponding to those previously described are designated by like reference numerals with a prime) it is contemplated that an outer layer fabric 44′ such as woven or knit mattress ticking fabric of polyester or the like may be laminated in place across a flame retardant fabric construction to form a covering 40′. In such a construction it is contemplated that a layer of adhesive 49′ such as a heat activated meltable scrim, film or the like may be used to effect bonding between the outer fabric layer 44′ and the flame retardant fabric construction 10′. Upon exposure to an exterior flame source, the outer layer 44′ and the layer of adhesive 49′ will tend to melt and burn through fairly quickly. However, the flame retardant fabric construction 10′ will act as a flame barrier against burn through into the interior of the mattress and or box spring.

It is to be understood that while the constructions of coverings for mattresses and box springs have been illustrated as utilizing flame retardant fabric constructions 10, 10′ having a coating facing outwardly away from the interior and towards an outer layer, it is likewise contemplated that such a coated fabric may be arranged with the coating facing towards the interior.

It is also contemplated that the flame retardant fabric construction may define the outer surface of the mattress 32 and/or box spring 34 without an additional decorative outer layer. Such a simplified covering arrangement is illustrated in FIG. 5B in which elements corresponding to those previously described are designated by like reference numerals with a double prime. As will be appreciated, in such an arrangement the textile 12″ defines the outer surface of the mattress or box spring. Of course, such a construction may also be arranged over the mattress or boxy spring with the coating 14″ facing outwardly and defining the outer surface of the mattress or box spring. In such an arrangement a sheet and/or mattress pad (not shown) will nonetheless separate the user from the coating 14″.

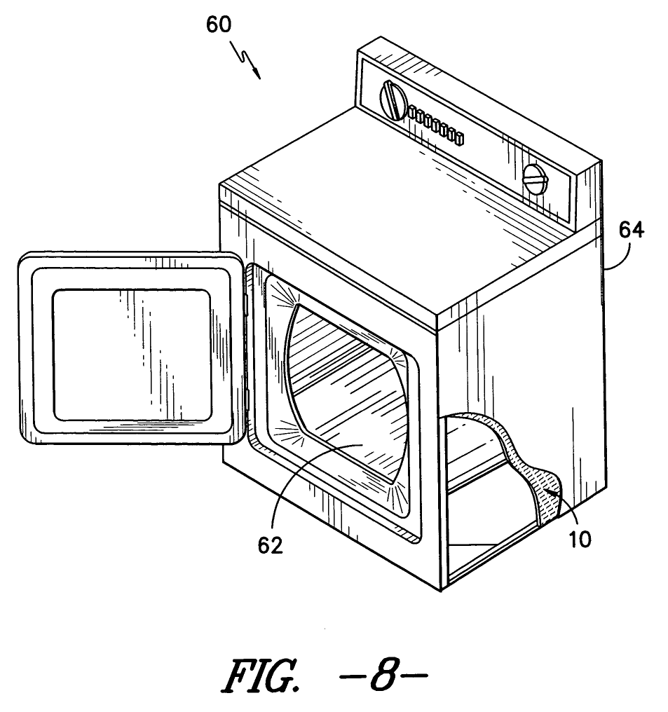

It is also contemplated that a coated flame retardant fabric construction 10 may have application in upholstery for furniture. By way of example only, and not limitation, in FIG. 6 there is illustrated a seating structure 50 covered by a multi-layer upholstery fabric 52 disposed over a foam cushion 54. As illustrated in FIG. 7, in one exemplary arrangement the upholstery fabric 52 includes an exterior surface layer 58 laminated across a flame retardant fabric construction 10 as previously described by a layer of heat activated adhesive 56. In such a construction it is contemplated that the exterior surface layer may be of virtually any desired material with the flame retardant fabric construction 10 providing substantial flammability resistance. Due to the substantial flame resistivity of the flame retardant fabric construction 10, it is contemplated that such a construction will readily pass the so called “crib 5” testing procedure as set forth in British Standard 5852 as previously described. Of course, it is to be understood that while the illustrated exemplary construction of furniture upholstery utilizes a flame retardant fabric construction 10 having a coating facing outwardly away from the interior and towards an exterior surface layer 58, it is likewise contemplated that such a coated fabric construction may be arranged with the coating facing towards the interior.

It is also contemplated that the flame retardant fabric construction may define the outer surface of the upholstery fabric across a furniture structure without an additional decorative outer layer. Such a simplified upholstery fabric 52′ is illustrated in FIG. 7A. As will be appreciated, in such an arrangement the textile 12 defines the outer surface of the upholstery fabric. Due to the substantial flame resistivity of fabric construction a substantial level of protection is provided.

It is also contemplated that the fabric construction 10 of enhanced flame resistance may have application as an insulating material in heat generating appliances such as stoves, clothes dryers and the like. By way of example only, and not limitation, in FIG. 8 there is illustrated a clothes dryer 60 having a heated interior chamber 62 surrounded by a cabinet 64. As illustrated, the fabric construction 10 may be disposed within the cabinet 64 so as to provide a flame barrier at least partially surrounding the interior chamber 62.

While the reasons for the flame resistance of the fabric construction 10 are not fully understood, it is believed that the polymeric coating of intumescent character provides a heat sink which disperses flame energy so as to efficiently prevent the material from being raised above a combustion temperature. While it is believed that such characteristics may have existed in prior fabrics incorporating substantial percentages of refractory fiber materials, it is not believed that such characteristics have hereto for been achievable in fabrics having little or no refractory fiber content. Moreover, it is surprising that such dramatic performance is achievable at the low coating weights which have been found to be suitable.

While the present invention has been illustrated and described in relation to certain potentially preferred embodiments and practices, it is to be understood that such embodiments and practices are illustrative and exemplary only and that the present invention is in no event to be limited thereto. Rather, it is contemplated that modifications and variations to the present invention will no doubt occur to those of skill in the art upon reading the above description and/or through a practice of the invention. It is therefore contemplated and intended that the present invention shall extend to all such modifications and variations which incorporate the broad principles of the present invention within the full spirit and scope thereof.

1. A pliable sheet material of fire-retardant character for use in at least one of a mattress, a box spring, a seating furniture structure and a heat generating appliance, the sheet material comprising: a flame resistant textile construction, wherein the flame resistant textile construction comprises a fibrous textile layer formed predominantly from non-refractory fibers, and wherein the flame resistant textile construction is characterized by a level of flame resistance such that when the flame resistant textile construction is in a horizontal position, flame impingement across one side of the flame resistant textile construction for a period of at least 70 seconds by a burner delivering propane having a heat of combustion of 46.5 MJ/Kg does not burn through the flame resistant textile construction and such that when the flame resistant textile construction is in a vertical position, flame impingement across one side of the flame resistant textile construction for a period of at least 50 seconds by said burner delivering propane having a heat of combustion of 46.5 MJ/Kg does not burn through the flame resistant textile construction, wherein said burner has a plurality of equally spaced holes each having a diameter in the range of 1.17 mm to 1.22 mm and spaced 8.5 mm apart and wherein the flow rate of propane to the burner is about 0.38 liters per minute per hole in the horizontal position and about 0.24 liters per minute per hole in the vertical position.

2. The invention as recited in claim 1, wherein the fibrous textile layer is a woven fabric.

3. The invention as recited in claim 1, wherein the fibrous textile layer is a knitted fabric.

4. The invention as recited in claim 1, wherein the fibrous textile layer is a nonwoven construction.

5. The invention as recited in claim 1, wherein the fibrous textile layer is at least partially coated with a polymeric coating.

6. The invention as recited in claim 5, wherein the polymeric coating is an intumescent coating.

7. The invention as recited in claim 6, wherein the polymeric coating comprises a polymeric binder blended with a flame retardant composition, the flame retardant composition comprising an acid donor, a carbon donor and a blowing agent.

8. A textile covering of fire-retardant character for use in overlying relation to at least one of a mattress, a box spring and a seating furniture structure, the textile covering comprising: a decorative exterior fabric and a flame resistant textile construction disposed in attached underlying relation to the exterior fabric, wherein the flame resistant textile construction comprises a fibrous textile layer formed predominantly from non-refractory fibers, and wherein the flame resistant textile construction is characterized by a level of flame resistance such that when the flame resistant textile construction is in a horizontal position, flame impingement across one side of the flame resistant textile construction for a period of at least 70 seconds by a burner delivering propane having a heat of combustion of 46.5 MJ/Kg does not burn through the flame resistant textile construction and such that when the flame resistant textile construction is in a vertical position, flame impingement across one side of the flame resistant textile construction for a period of at least 50 seconds by said burner delivering propane having a heat of combustion of 46.5 MJ/Kg does not burn through the flame resistant textile construction, wherein said burner has a plurality of equally spaced holes each having a diameter in the range of 1.17 mm to 1.22 mm and spaced 8.5 mm apart and wherein the flow rate of propane to the burner is about 0.38 liters per minute per hole in the horizontal position and about 0.24 liters per minute per hole in the vertical position.

9. The invention as recited in claim 8, wherein the exterior fabric is quilted to the flame resistant textile construction.

10. The invention as recited in claim 9, wherein the exterior fabric is polyester.

11. The invention as recited in claim 8, wherein the exterior fabric is adhesively bonded to the flame resistant textile construction.

12. The invention as recited in claim 11, wherein the exterior fabric is polyester.

13. The invention as recited in claim 8, wherein the fibrous textile layer is a woven fabric.

14. The invention as recited in claim 8, wherein the fibrous textile layer is a knitted fabric.

15. The invention as recited in claim 8, wherein the fibrous textile layer is a nonwoven construction.

16. The invention as recited in claim 8, wherein the fibrous textile layer is at least partially coated on at least one side with a polymeric coating.

17. The invention as recited in claim 16, wherein the polymeric coating is an intumescent coating.

18. The invention as recited in claim 17, wherein the polymeric coating comprises a polymeric binder blended with a flame retardant composition, the flame retardant composition comprising an acid donor, a carbon donor and a blowing agent.

19. The invention as recited in claim 17, wherein the coating is disposed between the exterior fabric and the fibrous textile layer.

20. A mattress comprising the pliable sheet material of claim 1.

21. A box spring comprising the pliable sheet material of claim 1.

22. A sofa comprising the pliable sheet material of claim 1.

23. A heat generating appliance comprising an interior heated chamber and the pliable sheet material of claim 1 disposed in insulating surrounding relation to the heated chamber.

24. A mattress comprising the textile covering of claim 8.

25. A box spring comprising the textile covering of claim 8.

26. A sofa comprising the textile covering of claim 8.
